(19) United States
(12) Patent Application Publication
(10) Pub. No.: US 2005/0231934 A1
(43) Pub. Date: Oct. 20, 2005

(54) Double reflection backlight module

(76) Inventor: Kuo-Yen Lai, Hsin-Chu (TW)

Correspondence Address: HungChang Lin, 8 Schindler Ct., Silver Spring, MD, 20903, US

(21) Appl. No.: 10/826,328

(22) Filed: Apr. 19, 2004

(51) Int. Cl. G01D 11/28

(52) U.S. Cl. 362/29

(57) ABSTRACT

A backlight for a large area display panel is derived from a remote point light source. A light from the point light source is first reflected by a first reflecting unit to spread the light in one direction. The reflected light from the first reflecting unit is reflected again by a second reflecting unit to spread the light in another direction. The spread light from the second reflecting unit is projected behind the display panel screen to furnish the backlight. The reflecting surfaces are fabricated with a ladder convex gratings, a ladder concave gratings, a ladder slant gratings or a matrix array of domes.

### BACKGROUND OF THE INVENTION

1. Field of the Invention

This invention relates to large screen display panel, particularly to the backlight for the large screen display panel.

2. Brief Description of Related Art

FIGS. 1A and 1B shows prior art backlight system for a large screen display panel disclosed in U.S. Pat. No. 6,685,343. FIG. 1A shows a three-dimensional view of the system. The display screen 12 is illuminated from a linear light source 16 and a transparent board 14. The linear light source is placed along one edge 14a of the transparent board 14. The transparent board 14 is etched with parallel sawtooth grooves 18 aligned diagonally along the front side 14b of the board 14 for reflecting the light toward the backside 14c, which butts against the display screen 12. The reflected light beam 24 is incident on the display screen 12 to supply the required backlight.

FIG. 1B shows the cross-section I—I of the FIG. 1A. The light from the light source 16 is incident on the sawtooth grooves from one edge of the transparent board 14 One side of the sawtooth groove 18 reflects the incident light and the reflected light beam 24 is projected through the front side of the transparent board 14 onto the display screen 12.

In this prior art, the light source 16 must be of equal length as one edge of the display screen 14 and placed along one side of the display screen.

### SUMMARY OF THE INVENTION

An object of the present invention is to reduce the length of the light source for a large display screen backlight. Another object of the present invention is to use a remote light source.

These objects are achieved by using a point source of light remotely located and projecting through a double reflection optical system to furnish backlight to the display screen. The backlight system comprises a first reflecting unit to spread the light in one direction and a second reflecting unit to spread the light in an orthogonal direction. By spreading the light in two directions, the spread light provides a large area backlight for a display screen. The spreading of the light can be achieved with ladder cylindrical gratings or ladder slant on an incline as a reflecting surface. Other contours of the reflecting surface such as convex, concave contours, etc are also possible. The spreading of the light can also be achieved by reflections from an array of domes.

### BRIEF DESCRIPTION OF THE DRAWINGS

FIG. 1A shows a prior art backlight system for a large display panel; FIG. 1B shows the cross-section of FIG. 1A

FIG. 2 shows a first principal structure of the present invention using a point source of light transmitting through optical lens and two reflectors to diffuse the light onto a large display screen.

FIG. 3 shows a second principal structure of the invention using a ladder slant reflector for the first reflector unit.

FIG. 4 shows a third principal structure of the invention using a ladder concave reflector for the first reflecting unit.

FIG. 5 shows a first embodiment of the invention.

FIG. 6 shows a second embodiment of the present invention adding a polarizer plate to FIG. 5.

FIG. 7 shows a third embodiment of the present invention.

FIG. 8 shows a fourth embodiment of the present invention adding a polarizer plate to FIG. 7.

FIG. 9 shows a fifth embodiment of the present invention with an integrated double reflection structure.

FIG. 10 shows a sixth embodiment of the present invention adding a polarizer plate to FIG. 9.

FIG. 11 shows a variation of light source with a parabolic reflector.

FIG. 12 shows the seventh embodiment of the present invention with an elevated point light source.

FIG. 13 shows an eighth embodiment of the present invention with an arc shape first reflecting unit.

FIG. 14 shows a ninth embodiment of the present invention with a curved surface as the first reflecting unit.

FIG. 15 shows a tenth embodiment of the present invention with ladder slant gratings for the first reflecting unit and ladder cylindrical gratings for the second reflecting unit as a full view of the second principal shown FIG. 3.

FIG. 16 shows three dimensional view of the present invention.

FIG. 17A shows an eleventh embodiment of the present invention with ladder cylindrical gratings on an incline serving as reflecting surfaces of the second reflecting unit; FIG. 17B shows a matrix array of domes on an incline serving as reflecting surfaces of the second reflecting unit.

### DETAILED DESCRIPTION OF THE INVENTION

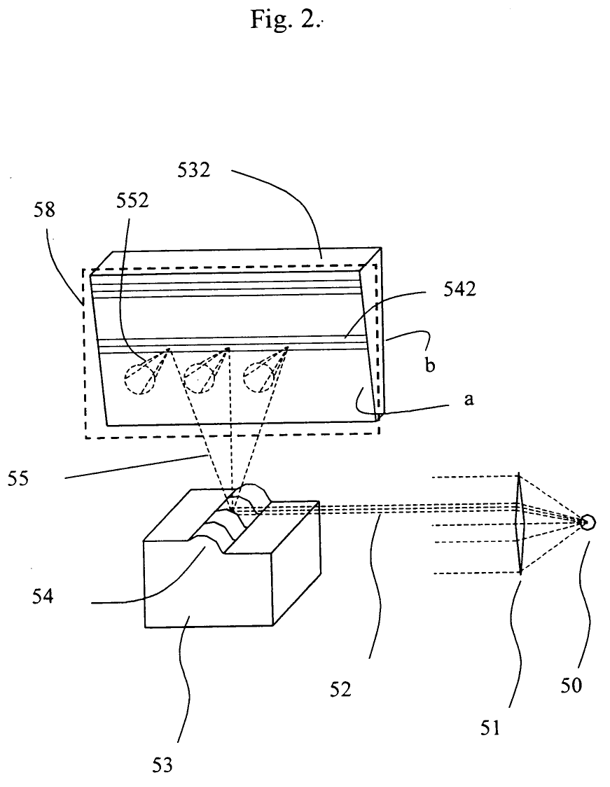

FIG. 2 shows the first principal structure of the present invention. A point light source 50 is remotely located from a display panel 58 (shown as a dotted frame). The point light source is located at the focal point of a lens 51 and is transmitted through the lens 51 to produce packets of parallel light beams 52, which is incident on a first reflector unit 53. The first reflector unit 53 has a group of cylindrical reflecting surfaces 54, which reflect the incident light packet 52 and spread out as first reflected light beams 55. The first reflected light beams 55 are reflected and projected to a second reflecting unit 532 which has the similar ladder convex reflecting structure 54 as the first reflector unit 53. The second reflecting unit 532 has a tilted front surface “a” with respect to back surface “b”. The light beams 552 reflected from the second reflecting unit spread out the light beams 552 to backlight a larger area display panel screen 58 placed in front as shown in dotted line.

The first reflecting unit 53 is fabricated with multiple segments of convex gratings 542 on an incline as reflecting ladder surfaces 54. The convex reflecting surface reflects and spreads the light band 52 horizontally. Other contours of the reflecting surfaces are also applicable, so long as the reflected light beam is spread out, such as a ladder concave contour, a ladder slant contour or a curved contour.

The second reflecting unit 532 has an inclined surface “a” with either a ladder convex gratings 542 as the reflecting surfaces.

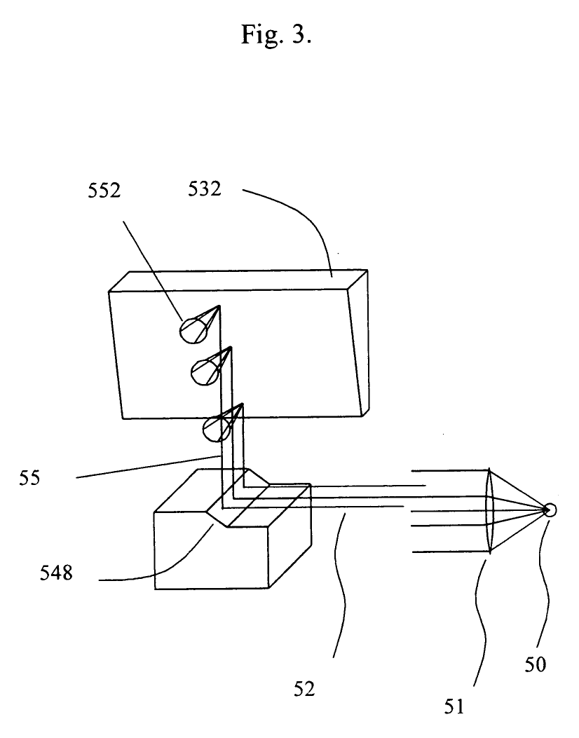

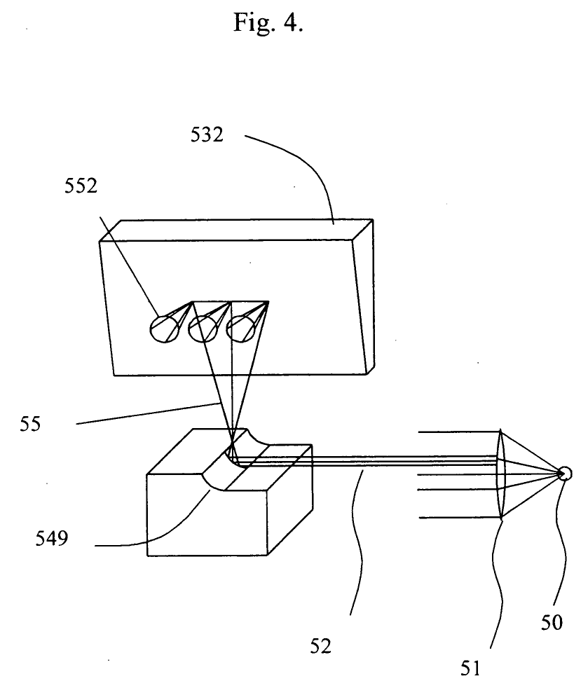

FIG. 3 shows a second principal structure of the present invention. The reference numerals 50, 51 and 52 correspond to same parts as in FIG. 2. The ladder flat surface 548 reflects the incident light packets 52 as a first reflection, and the reflected light 55 of different packets from the 548 spread vertically at the second reflecting unit 532. The second reflecting unit 532 has either ladder convex gratings (similar convex gratings 54 in FIG. 2 or a ladder concave gratings (similar to the ladder concave 549 in FIG. 4) to spread out the incident light 55 as a second reflection light 552 and emitted for a backlight. Thus, a large area backlight is obtained.

FIG. 4 shows a third principal structure of the present invention. The principle is similar to that of FIG. 2 and like reference numerals denote the corresponding parts in FIG. 3. The exception is that the reflecting surface 549 of the first reflecting unit is concave, such that each packet of light beam 52 incident on the convex surface spreads the light beam 55 horizontally onto the reflecting surface of the second reflecting unit 532 which has either [a] concave gratings or convex gratings. With large number of light packets incident onto the first reflecting surface 549, the reflected light 552 from the second reflecting unit 532 provides a large area backlight.

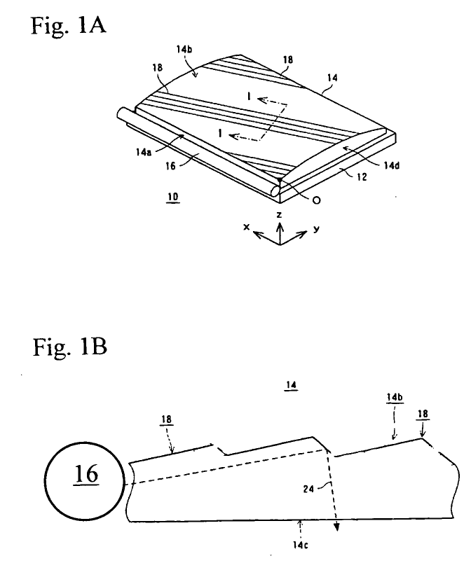

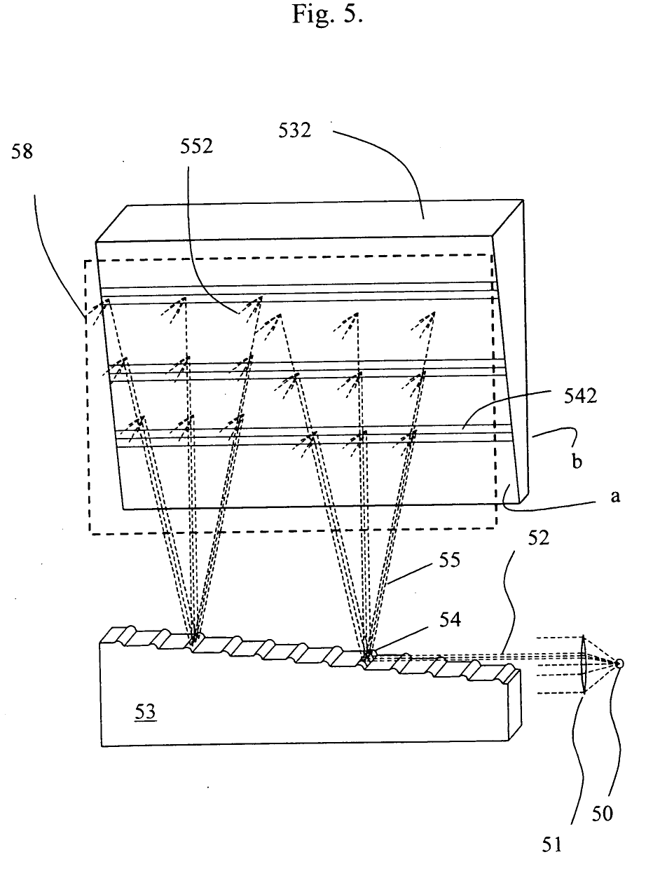

FIG. 5 shows a first embodiment for implementing the double reflection back light using the first principal structure described in FIG. 2. Like reference numerals correspond to the same parts in FIG. 2. The first reflecting surface 54 of the first reflecting unit 53 has a inclined structure with cylindrical gratings. The rounded gratings 54 spread the reflected light beam 52 horizontally onto the second reflecting surface “a” of the second reflecting unit 532. The different light packets 52 projects onto different steps of the grated incline to spread the first reflected light beams 55 vertically. With spread out horizontal and vertical reflections 55, the large area back light for the display screen 58 is obtained. The reflecting gratings 542 can be either multiple convex gratings or multiple concave gratings. However, multiple flat surface gratings such as that shown in FIG. 1B can also be used to obtain [worse] lesser spreading out performance.

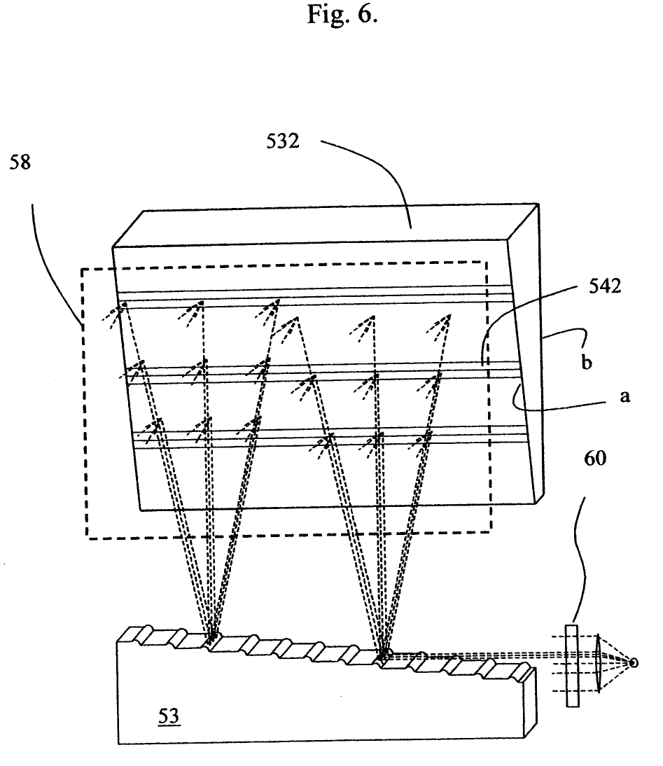

FIG. 6 shows a second embodiment of the invention and is similar to FIG. 5, except that a polarizer plate 60 is inserted between the first lens 51 and the stepped incline of the first reflecting unit 53 to provide a polarized light for the display to use. The polarizer plate can be inserted into any other places where the light passes but a smaller one is needed if placed closer to the point light source 50.

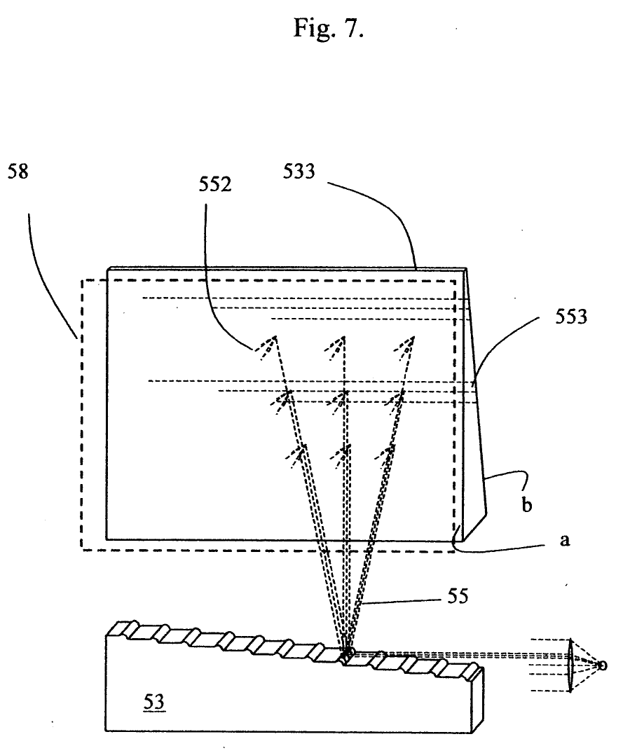

FIG. 7 shows a third embodiment of the invention. The structure is similar to that in FIG. 6 except that “b” surface is slanted with either ladder convex or concave gratings. The second reflecting unit 533 is transparent so that the light reflected from surface “b” is transmitted out from surface “a”. Other like reference numerals correspond to the same parts as in FIG. 6. The reflecting gratings 543 can be ladder concave gratings, ladder convex gratings or ladder slant grating.

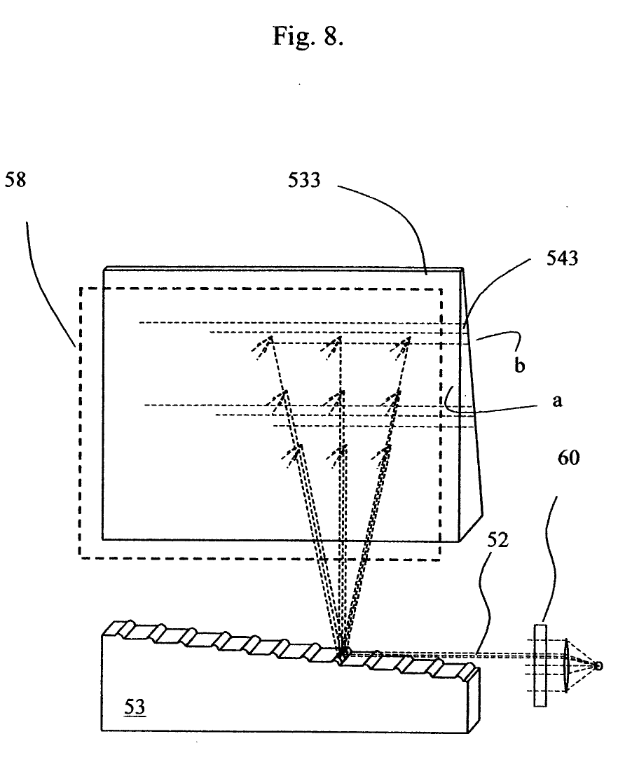

FIG. 8 shows a fourth embodiment of the invention. The structure is similar to FIG. 7, except that a polarizing plate 60 is inserted between the first lens 51 and the first reflecting unit 53. Like reference numerals correspond to the same parts as in FIG. 7. The polarizer 60 serves the same function as that shown in FIG. 6.

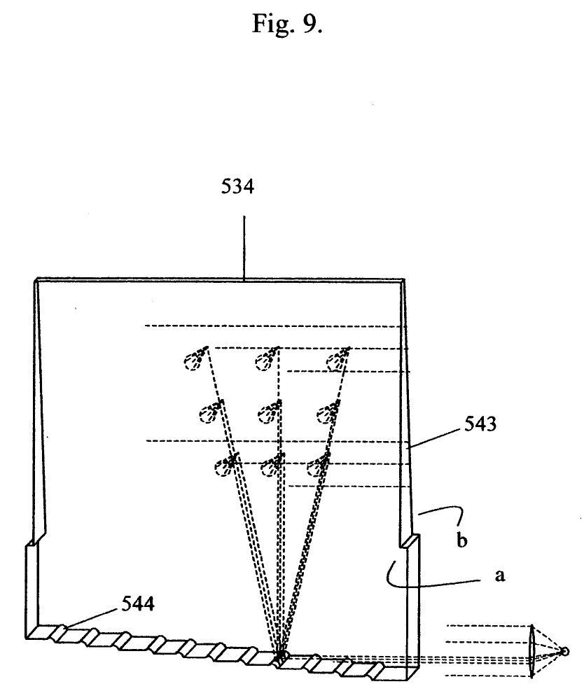

FIG. 9 shows a fifth embodiment of the invention. In this structure, the first reflector 544 unit and the second reflector unit 543 are integrated in a single structure of a trapezoid. The first reflector unit has stepped gratings similar to that shown in FIG. 7 forming the base of the trapezoid.

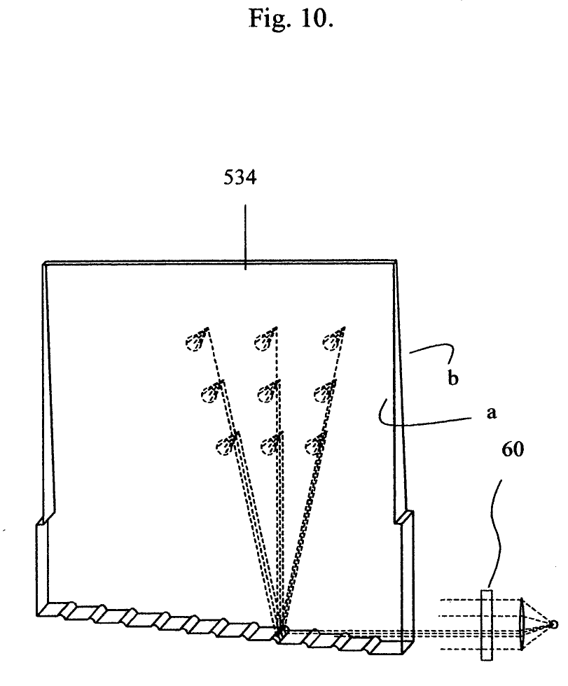

FIG. 10 shows a sixth embodiment of the present invention, which is similar to FIG. 9, except that a polarizer plate 60 is inserted between the first lens and the first reflecting unit, serving the same function as that in FIGS. 6 and 8.

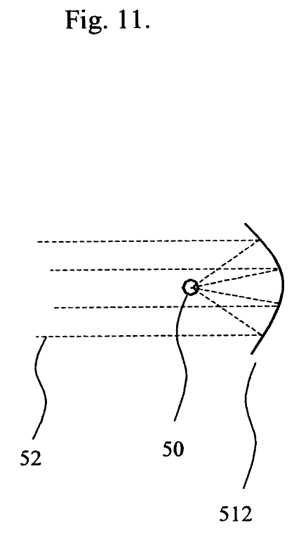

FIG. 11 shows another embodiment of the point light source 50. The point light source 50 is placed at the focal point of the parabolic reflector 512. The light from the source 50 is reflected by the reflector 512 to produce parallel light beams 52.

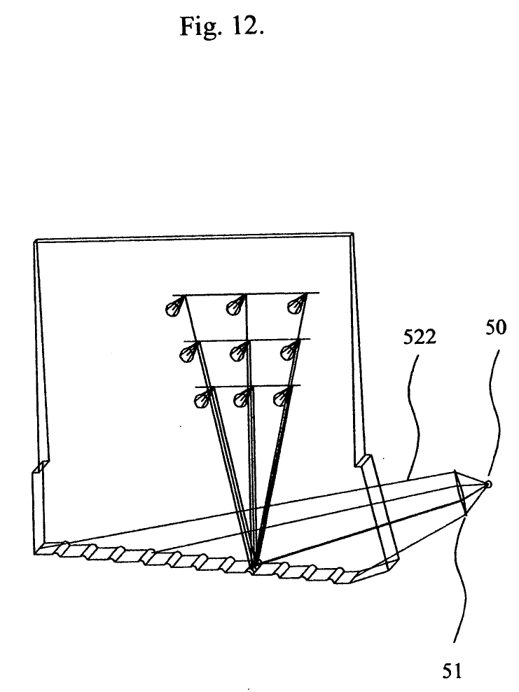

FIG. 12 shows a seventh embodiment of the invention. Instead of placing the light source at the same elevation as the first reflecting unit as that shown in FIGS. 5-10, the light source is placed in an elevated position to irradiate the first reflector unit 544 at an angle. FIG. 12 shows the elevated light source 50 with divergent light beam 522 irradiating the first reflecting unit 544.

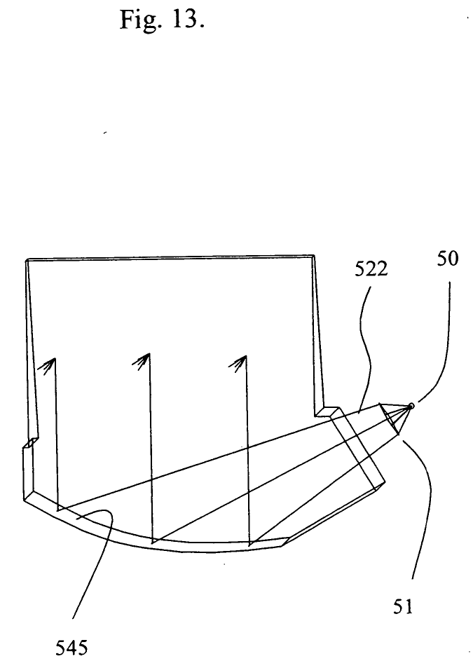

FIG. 13 shows an eighth embodiment of the invention. An elevated light source 50 radiates a fan-out light packet 522 through a lens 51 to a curved ribbon first reflector unit 545. The lens 51 is a divergent lens which fans out the light beam incident on the first reflecting surface 545. The reflected light beams from the first reflecting surface 545 is then processed as in previous embodiments such as that shown in FIG. 9.

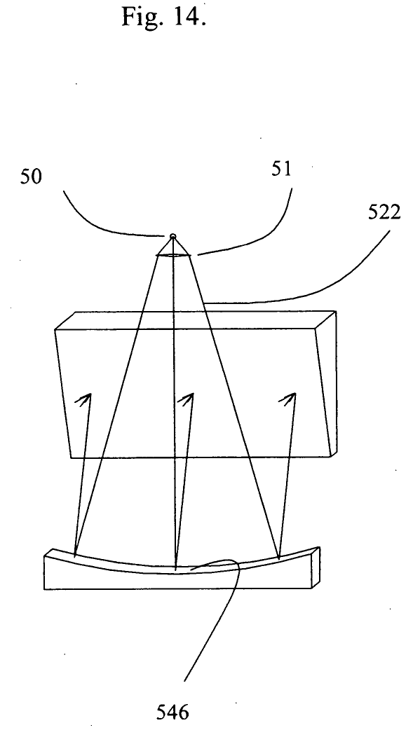

FIG. 14 shows a ninth embodiment of the invention. The structure is similar to that in FIG. 13, except that the light source is moved over above the second light reflecting unit. The light packets 522 radiating from the point light source 50 through a lens 51 to the first curved reflecting unit 546, which then reflects the light packets 522 toward the second reflecting unit.

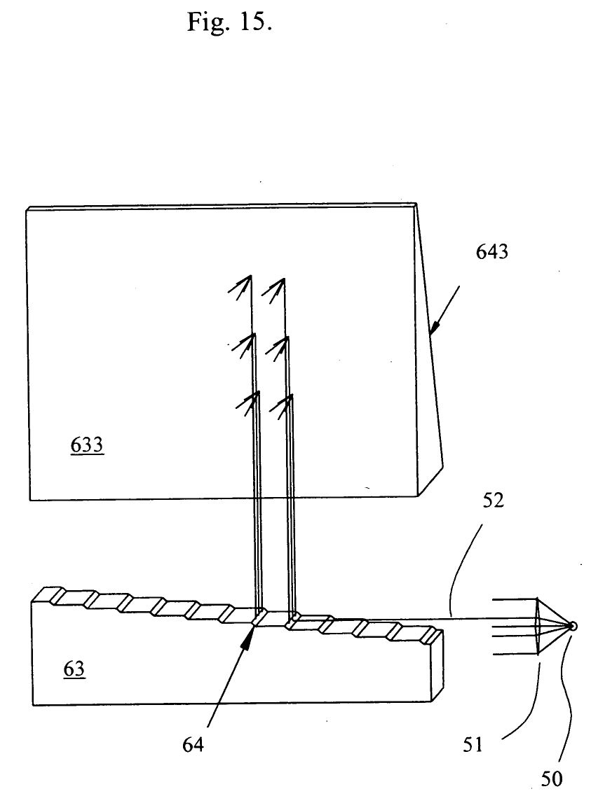

FIG. 15 shows a tenth embodiment of the invention. The first reflecting unit 63 with ladder slant surface gratings 64 is placed under the second reflecting unit 633. The light incident from the point light source 50 through a lens 51 is reflected by the ladder slant 64 of the first reflecting unit 63, which are sawtooth steps similar to that in FIG. 3

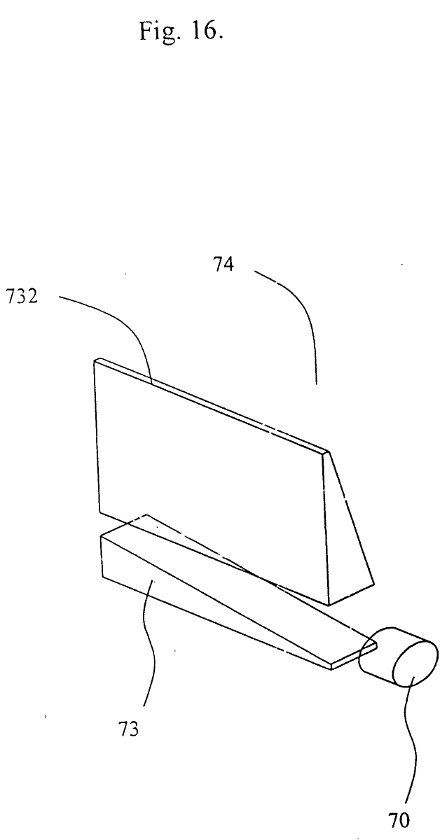

FIG. 16 show a three dimensional view of the present invention, showing a light source 70, a first reflecting unit 73 and a second reflecting unit 732. The entire backlight structure is enclosed inside a large screen display unit 74.

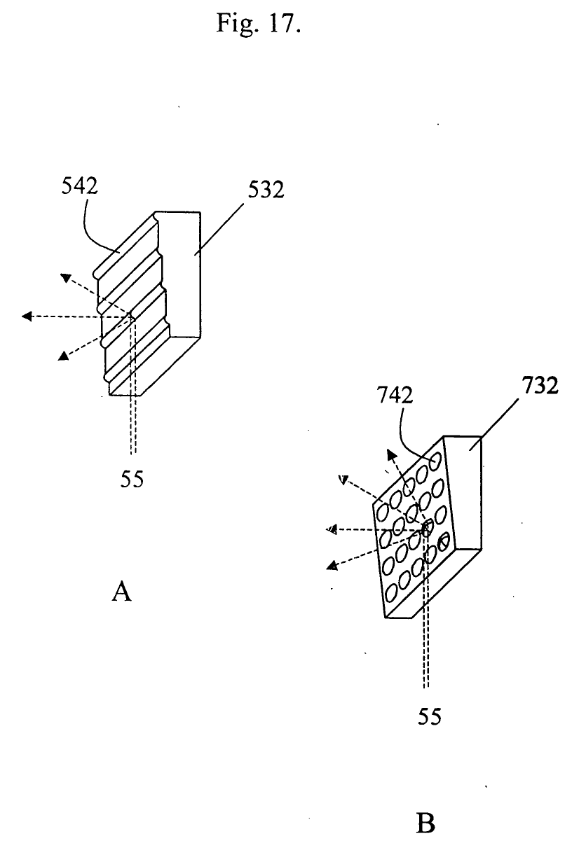

FIGS. 17A,B show an eleventh embodiment of the present invention to spread the reflection from the second reflection unit 532, 732 respectively. The reflecting surface of the second reflecting unit 532 in FIG. 17A is formed with ladder curved gratings 542, which reflect and spread the incident light 55 from first reflecting unit in two dimensions. In FIG. 17B, the reflecting surface of the second reflecting unit 732 is formed with a matrix of domes 742, which reflect and spread the incident light 55 from the first reflecting unit in three dimensions. The domes can be hemispheric, elliptical, recessed, etc.

While the preferred embodiments of the invention have been described, it will be apparent to those skilled in the art that various modifications may be made to the embodiments without departing from the spirit of the invention. Such modifications are all within the scope of the present invention.

1. A backlight system for a display panel, comprising:
a point light source;
a first light reflecting unit to reflect and to spread the incident light beam from said light source in a first direction; and
a second light reflecting unit to spread the reflected light from said first light reflecting unit in a second direction and to project the reflected light from said second light reflecting unit onto a display screen as a backlight.

2. The backlight system as described in claim 1, wherein said first light reflecting unit has a reflecting surface selected from the contour group consisting of ladder concave contour, ladder convex contour, ladder slant contour, and curved surface contours [selected from the group consisting of ladder concave contour, ladder convex contour, ladder slant planar contour, and curved surface contours].

3. The backlight system as described in claim 1, wherein said second reflecting unit has a sloped reflecting surface having contours selected from the group consisting of ladder concave contour, ladder convex contour, ladder slant contour, and matrix array of domes.

4. The backlight system as described in claim 1, wherein said reflecting surface of the second reflecting unit is tilted toward the display screen.

5. The backlight system as described in claim 4, wherein said reflecting surface is the front surface of the second reflecting unit facing the display screen.

6. The backlight system as described in claim 4, wherein said reflecting surface is the inner back surface of the second reflecting unit away from the display screen and the second reflecting unit is transparent.

7. The backlight system as described in claim 1, wherein said second reflecting unit lies over said first reflecting unit.

8. The backlight system as described in claim 1, wherein said first reflecting unit is integrated with said second reflecting unit.

9. The backlight system as described in claim 1, further comprising a parabolic mirror to reflect and to project the light from said light source toward said first reflecting unit.

10. The backlight system as described in claim 1, further comprising a polarizer plate inserted in the light pass.

11. The backlight system as described in claim 10, wherein said polarizer plate is inserted between said light source and said first reflecting unit.

12. The backlight system as described in claim 1, wherein said light source is at the same elevation as the first reflecting unit.

13. The backlight system as described in claim, wherein said light source is elevated with respect to said first reflecting unit.

14. The backlight system as described in claim 1, wherein said light source is elevated over the top of said second reflecting unit.

15. The backlight system as described in claim 3, wherein said matrix array of domes is selected from the group consisting of hemispheric domes, elliptical domes, and recessed domes.
